(19) United States
(12) Patent Application Publication
(10) Pub. No.: US 2018/0371686 A1
(43) Pub. Date: Dec. 27, 2018

(54) PROCESS FOR FORMING A SEAM CONSTRUCTION ON A SUBSTRATE AND THE SEAM CONSTRUCTION FORMED THEREBY

(71) Applicant: Well & David Corp., Kaohsiung (TW)

(72) Inventors: Ker-Chang Hsieh, Kaohsiung City (TW); Chi-Cheng Cheng, Kaohsiung City (TW); New-Jin Ho, Kaohsiung City (TW)

(73) Assignee: Well & David Corp., Kaohsiung (TW)

(21) Appl. No.: 15/629,646

(22) Filed: Jun. 21, 2017

(51) Int. Cl. D06M 15/55; C09J 163/00

(52) U.S. Cl. CPC D06M 15/55; C09J 163/00

(57) ABSTRACT

A process for forming a seam construction on a substrate includes steps of: a) providing a first thread coated with a first curable resinous material; b) providing a second thread coated with a second curable resinous material; c) forming a stitch knot; and d) curing the stitch knot to chemically bond the first and second curable resinous materials together.

### FIELD

The disclosure relates to a process for forming a seam construction on a substrate, and more particularly to a process for making a seam construction having enhanced construction strength on a substrate. The disclosure also relates to the seam construction formed thereby.

### BACKGROUND

Referring to FIG. 1, a conventional seam construction 1 is shown to be formed on a fabric 2. The seam construction 1 includes a first thread 11 and a second thread 12. A plurality of stitch knots (A) are formed by interlacing the first thread 11 with the second thread 12. Specifically, a plurality of stitches 111 are formed on two opposite surfaces of the fabric 2 by the first thread 11. The second thread 12 is caused to pass through the stitches 111 formed on one of the opposite surfaces of the fabric 2 so as to interlace with the first thread 11 to form the stitch knots (A) on the fabric 2. Friction produced at contact points (B) between the interlaced first and second threads 11, 12 at the stitch knots (A) provides construction strength.

However, when the fabric 2 is pulled in use, the contact between the first thread 11 and the second thread 12 at some of the contact points (B) may become loose, thereby impairing the construction strength. In order to overcome the problem, an adhesive patch is generally applied to each of the contact points (B) to cause the first and second threads 11, 12 to adhere to each other at the contact points (B). However, it is time-consuming and laborious to apply the adhesive patch to each of the contact points (B). Furthermore, it is uncomfortable to wear clothes made from the fabric 2 due to the presence of the relatively stiff adhesive patches.

### SUMMARY

An object of the disclosure is to provide a process for making a seam construction having enhanced construction strength on a substrate such that the construction strength can be maintained even when the substrate is pulled.

Another object of the disclosure is to provide a seam construction made by the process.

According to a first aspect of the disclosure, there is provided a process for forming a seam construction on a substrate, comprising steps of:

a) providing a first thread coated with a first curable resinous material;

b) providing a second thread coated with a second curable resinous material which is different from the first curable resinous material;

c) forming on the substrate a stitch knot by virtue of interlacing the first thread with the second thread; and

d) curing the stitch knot to chemically bond the first and second curable resinous materials together.

According to a second aspect of the disclosure, there is provided a seam construction made by the aforesaid process.

### BRIEF DESCRIPTION OF THE DRAWINGS

Other features and advantages of the disclosure will become apparent in the following detailed description of the embodiment (s) with reference to the accompanying drawings, of which:

FIG. 1 is a fragmentary perspective view of a conventional seam configuration formed on a fabric;

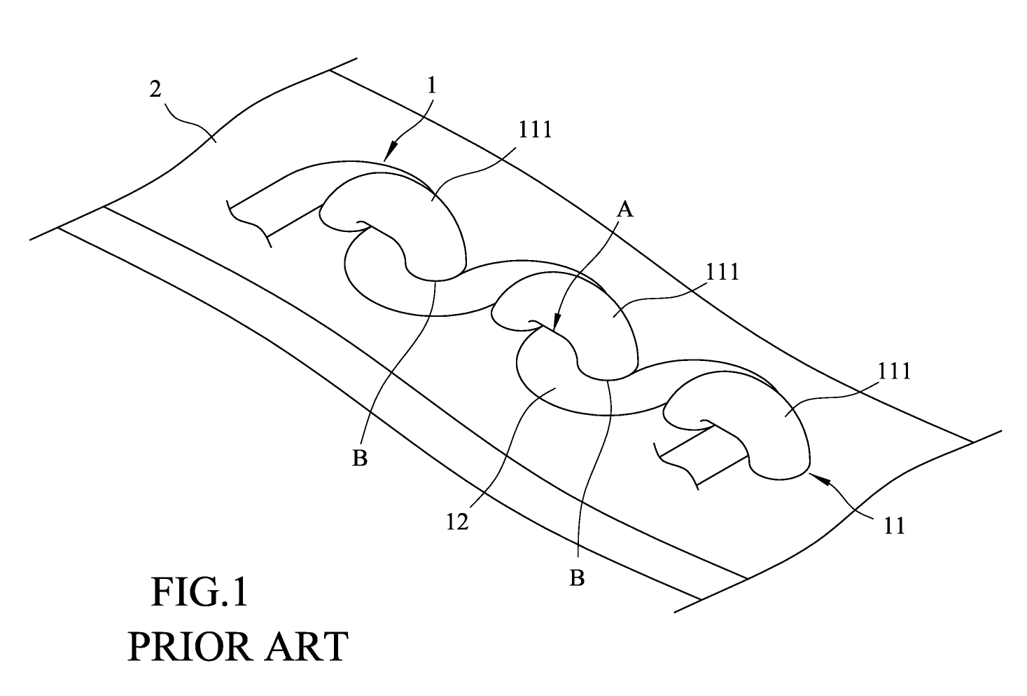

FIG. 2 is a flow diagram of an embodiment of a process for forming a seam construction on a substrate according to the disclosure;

FIG. 3 is a fragmentary perspective view of an embodiment of a seam construction according to the disclosure as viewed from a first surface of a substrate;

FIG. 4 is a fragmentary perspective view of the embodiment of the seam construction according to the disclosure as viewed from a second surface of the substrate opposite to the first surface of the substrate;

FIG. 5 is a schematic sectional view of the embodiment of the seam construction according to the disclosure as viewed from the first surface of the substrate; and

FIG. 6 is a schematic sectional view of the embodiment of the seam construction according to the disclosure to illustrate bonding of a first curable resinous material coated on a first thread of the embodiment of the seam construction to a second curable resinous material coated on a second thread of the embodiment of the seam construction.

### DETAILED DESCRIPTION

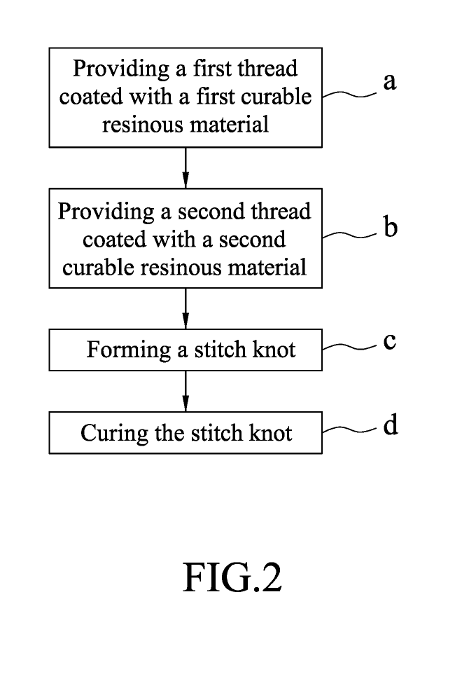

As shown in FIG. 2, an embodiment of a process for forming a seam construction on a substrate according to the disclosure includes steps of: a) providing a first thread coated with a first curable resinous material; b) providing a second thread coated with a second curable resinous material; c) forming a plurality of stitch knots; and d) curing the stitch knots.

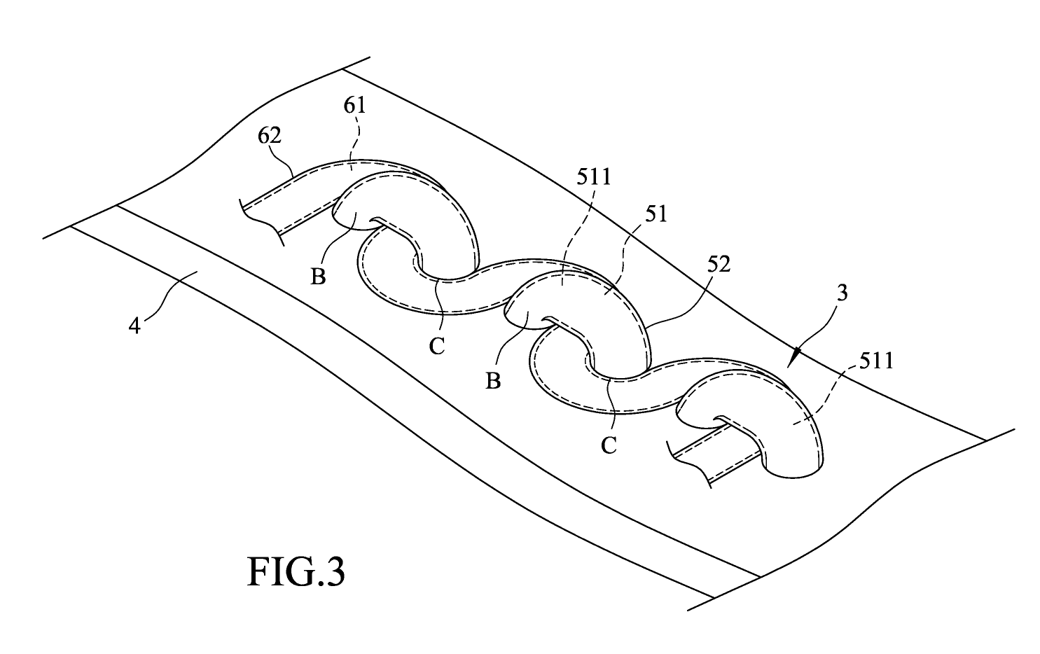

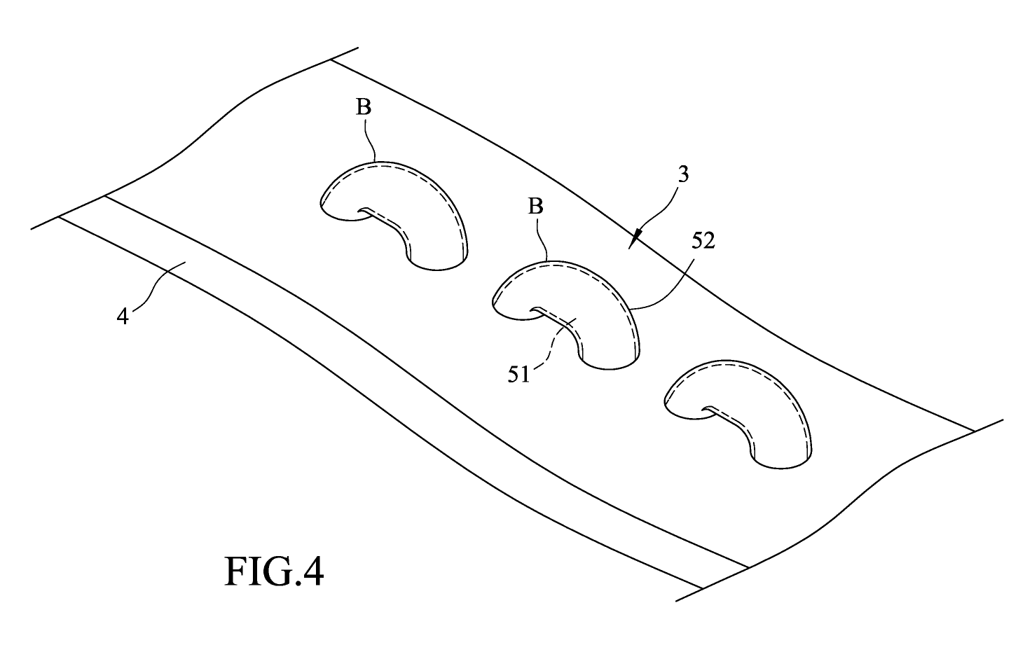

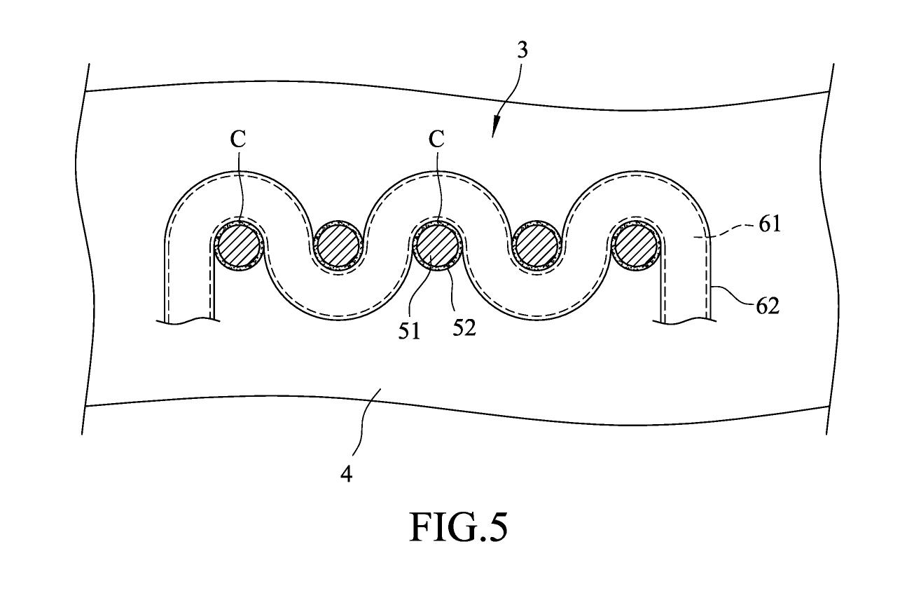

Referring to FIGS. 3 to 6, in step a), a first thread 51 is coated with a first curable resinous material 52. The first thread 51 used in the embodiment is made from a first polymeric material. The first curable resinous material 52 used in the embodiment is a bisphenol A-allyl amine type benzoxazine resin. Specifically, the coating of the first thread 51 with the first curable resinous material 52 may be performed by immersing the first thread 51 in a melt of the first curable resinous material 52 or a dispersion or solution of the first curable resinous material 52 in a volatile medium, followed by volatilization of the volatile medium if the volatile medium is contained and solidification of the first curable resinous material 52 at an ambient temperature.

In step b), a second thread 61 is coated with a second curable resinous material 62 which is different from the first curable resinous material 52. The second thread 61 is made from a second polymeric material which may be the same as or different from the first polymeric material for making the first thread 51. The second curable resinous material 62 used in the embodiment is a bisphenol A type epoxy resin. The coating of the second thread 61 with the second curable resinous material 62 may be performed in a manner similar to that described above for step a).

In step c), a plurality of stitch knots (B) are formed on a substrate 4 by interlacing the first thread 51 coated with the first curable resinous material 52 with the second thread 61 coated with the second curable resinous material 62. Specifically, a plurality of stitches 511 are formed on two opposite surfaces of the substrate 4 by the first thread 51 coated with the first curable resinous material 52. The second thread 61 coated with the second curable resinous material 62 is caused to pass through the stitches 511 formed on one of the two opposite surfaces of the substrate 4 so as to interlace with the first thread 51 coated with the first curable resinous material 52 to form the stitch knots (B) on the substrate 4. At the stitch knots (B) formed in step c), the first curable resinous material 52 coated on the first thread 51 merely contacts the second curable resinous material 62 coated on the second thread 61 at contact points (C). Examples of the substrate 4 suitable for the disclosure include, but are not limited to, a fabric, leather, and a combination thereof.

It should be noted that the manner for forming the stitch knots (B) is not limited to that described above, which is only illustrative.

In step d), the stitch knots (B) are cured at a baking temperature for a sufficient curing period so as to chemically bond the first and second curable resinous materials 52, 62 together at the stitch knots (B) (i.e., at the contact points (C)) so as to form a seam construction 3 on the substrate 4. In the embodiment in which a bisphenol A-allyl amine type benzoxazine resin is used as the first curable resinous material 52 and a bisphenol A type epoxy resin is used as the first curable resinous material 62, the curing step is performed at a baking temperature higher than 120° C. The baking temperatures and the corresponding curing periods for the curing treatment are shown in Table 1 below. It should be noted that in the curing treatment, the first and second curable resinous materials 52, 62 may chemically bond together at the stitch knots (B) (i.e., at the contact points (C)) only, and may not chemically bond to the substrate 4.

TABLE 1

| Baking temperature (° C.) | Curing period (minutes) |
|---|---|
| 120 | more than 120 |
| 150 | 95 |
| 180 | 14 |
| 200 | 6 |
| 220 | 3 |

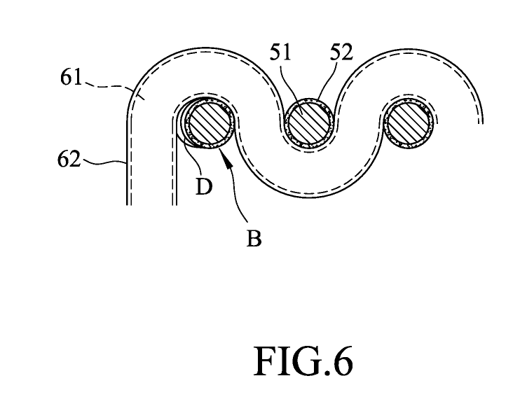

With reference to FIG. 6, even if a gap (D) is formed between the first curable resinous material 52 and the second curable resinous material 62 at the stitch knot (B), the first and second curable resinous material s 52, 62 may soften to fill the gap (D) during the curing step so as to chemically bond together.

In view of the aforesaid, in the process for forming the seam construction 3 according to the disclosure, the first and second curable resinous materials 52, 62 may chemically bond together at the stitch knots (B) (i.e., at the contact points (C)) after curing. Therefore, the seam construction 3 thus formed may have enhanced construction strength, and the aforesaid disadvantages encountered in the prior art may be overcome.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A process for forming a seam construction on a substrate, comprising steps of:
a) providing a first thread coated with a first curable resinous material;
b) providing a second thread coated with a second curable resinous material which is different from the first curable resinous material;
c) forming on the substrate a stitch knot by interlacing the first thread coated with the curable resinous material with the second thread coated with the second curable resinous material; and
d) curing the stitch knot to chemically bond the first and second curable resinous materials together.

2. The method according to claim 1, wherein the first curable resinous material is a bisphenol A-allyl amine type benzoxazine resin and the second curable resinous material is a bisphenol A type epoxy resin.

3. The method according to claim 2, wherein step d) is performed at a temperature higher than 120° C.

4. The method according to claim 1, wherein the substrate is selected from the group consisting of a fabric, leather, and a combination thereof.

5. A seam construction formed by the process according to claim 1.
